(19) United States
(12) Patent Application Publication
(10) Pub. No.: US 2004/0117485 A1
(43) Pub. Date: Jun. 17, 2004

(54) Apparatus, method, and computer program product for tunneling TCP based client-server applications

(75) Inventor: Guanghong Yang, San Jose, CA (US)

Correspondence Address: Patent Law Offices of Michael E. Woods, 89 Corte Cayuga, Greenbrae, CA, 94904-1307, US

(73) Assignee: Collatus Corporation, a Delaware Corporation

(21) Appl. No.: 10/678,347

(22) Filed: Oct. 3, 2003

Related U.S. Application Data
(60) Provisional application No. 60/430,744, filed on Dec. 3, 2002.

(51) Int. Cl. G06F 15/16

(52) U.S. Cl. 709/227

(57) ABSTRACT

Disclosed is a tunneling system, method and computer program product. The system includes a service publishing/tunneling server coupled to a wide-area network; and a service proxy, coupled to one or more computer systems, for implementing one or more service proxy functions; wherein a TCP service for the one or more client computer systems is available from the server through the service proxy. The method includes connecting a service proxy to a service publishing/tunneling server, wherein the server is coupled to a wide-area network and the service proxy is coupled to one or more computer systems for implementing one or more service proxy functions;sending, from the proxy, publishing information for a particular service to the server; c) receiving a service key for the particular service from the server; and d) using the service key to provide the particular service to the one or more client computer systems from the server through the service proxy. A computer program product including a computer readable medium carrying program instructions for tunneling TCP services when executed using two or more computing systems each coupled to a global area network, the executed program instructions executing a method, the method including connecting a service proxy to a service publishing/tunneling server, wherein the server is coupled to a wide-area network and the service proxy is coupled to one or more computer systems for implementing one or more service proxy functions; sending, from the proxy, publishing information for a particular service to the server; receiving a service key for the particular service from the server; and using the service key to provide the particular service to the one or more client computer systems from the server through the service proxy.

### CROSS-REFERENCE TO RELATED APPLICATIONS

The present application claims the benefit of the filing date of co-pending U.S. provisional application, application Ser. No. 60/430,744 filed Dec. 3, 2002, entitled “Systems and Methods for Tunneling TCP Based Client Server Applications,” the disclosure of which is hereby expressly incorporated by reference for all purposes.

### BACKGROUND OF THE INVENTION

This present invention relates to the communications over computer networks and more particularly, to systems and methods for tunneling TCP based client/server applications across enterprise network boundaries via global area computer network, such as Internet.

As interdependency between businesses in the Internet economy increases, enterprises rely heavily on communication with business partners, suppliers, and customers to conduct business operations successfully and expeditiously.

However, most enterprise networks today are protected by one or more security features, including firewalls. Firewalls help these enterprises increase control over the underlying data, which can increase their business privacy. The wide use of firewalls to partition off private networks from public networks contributes to solving a potential shortage of IPv4 addresses. As a side effect, firewalls split the whole Internet into many not-fully-bi-directionally-connected network islands. Connectivity between enterprises on these islands becomes problematic.

FIG. 1 is a schematic block diagram of a network system 100 divided into a plurality of “network islands” 105ᵢ. Each island 105ᵢ includes a firewall 110ᵢ and a plurality of computing systems (e.g., a server 115ᵢ, a desktop 120ᵢ and a laptop 125ᵢ). While each firewall 110ᵢ is often configured differently from other firewalls 110ᵢ, they each limit full bi-directional data flow. As shown in FIG. 1, each computing system that is behind firewall 110₁ is not freely accessible from another computing system that is behind firewall 110₂, although both of them have connections toward public Internet 130.

Besides firewall 110 filtering/blocking features, a major reason for the connectivity problem between computing systems behind different firewalls 110ᵢ is the different private address spaces they use. Firewall 110₁ and firewall 110₂ help to define different address spaces for the individual islands 105₁ and 105₂, respectively. In actuality, this isolates different private areas among the public Internet. By applying NAT (Network Address Translation), each computing system of each island 105ᵢ is able to access Internet 130, but will lose any direct IP connectivity into computing systems within each island 105ᵢ, unless special administration is used in cooperation with firewalls 110ᵢ.

Many TCP based client-server applications have been deployed in almost every enterprise. Although Web-based enterprise applications are starting rapidly to emerge, these TCP based client-server application are not replaced for daily operation of the enterprise due to the rich client functionalities that they provide. What is needed is a way to solve the access problems of TCP based client-server applications to permit TCP based server and client application to be able to work across enterprise network boundaries and work inside an enterprise network.

### SUMMARY OF THE INVENTION

Disclosed is a tunneling system, method and computer program product. The system includes a service publishing/tunneling server coupled to a wide-area network; and a service proxy, coupled to one or more computer systems, for implementing one or more service proxy functions; wherein a TCP service for the one or more client computer systems is available from the server through the service proxy. The method includes connecting a service proxy to a service publishing/tunneling server, wherein the server is coupled to a wide-area network and the service proxy is coupled to one or more computer systems for implementing one or more service proxy functions;sending, from the proxy, publishing information for a particular service to the server; c) receiving a service key for the particular service from the server; and d) using the service key to provide the particular service to the one or more client computer systems from the server through the service proxy. A computer program product including a computer readable medium carrying program instructions for tunneling TCP services when executed using two or more computing systems each coupled to a global area network, the executed program instructions executing a method, the method including connecting a service proxy to a service publishing/tunneling server, wherein the server is coupled to a wide-area network and the service proxy is coupled to one or more computer systems for implementing one or more service proxy functions; sending, from the proxy, publishing information for a particular service to the server; receiving a service key for the particular service from the server; and using the service key to provide the particular service to the one or more client computer systems from the server through the service proxy.

The present invention provides a way to solve the access problems of TCP based client-server applications to permit TCP based server and client application to be able to work across enterprise network boundaries and work inside an enterprise network.

### BRIEF DESCRIPTION OF THE DRAWINGS

FIG. 1 is a schematic block diagram of a network system divided into a plurality of “network islands;”

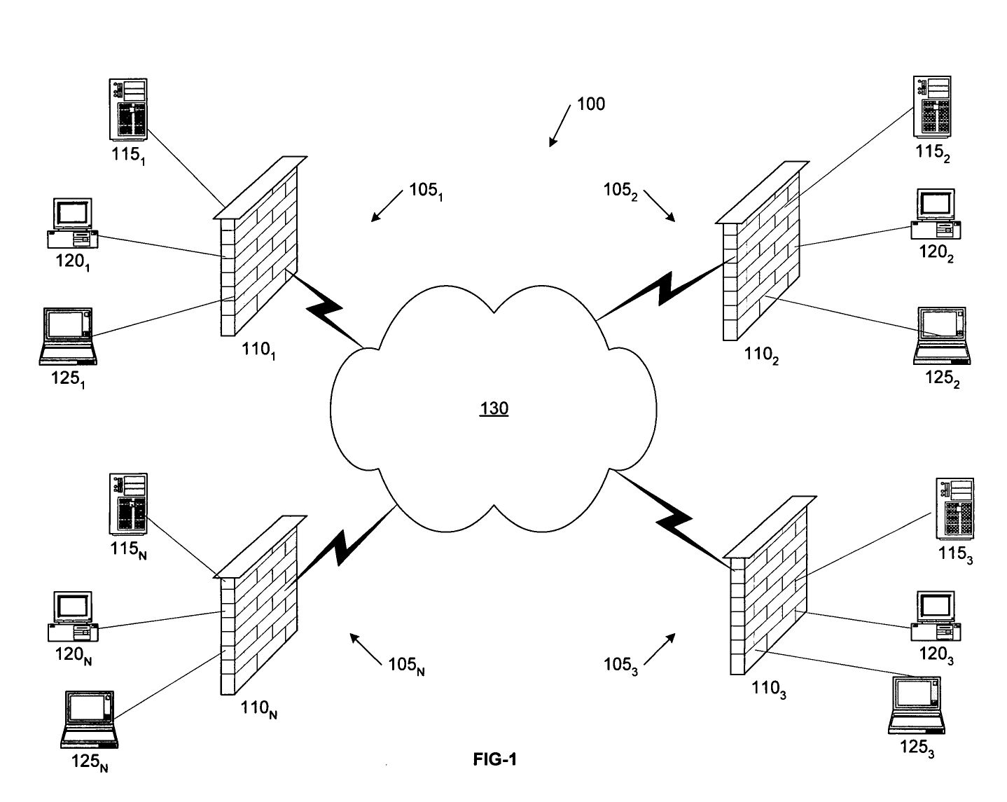

FIG. 2 is a schematic block diagram of a preferred embodiment for a TCP tunneling architecture;

FIG. 3 is a flowchart diagram of a publishing process that the service proxy uses to publish the service of a TCP based client/server application;

FIG. 4 is a flowchart of service key process for the server;

FIG. 5 is a functional block diagram illustrating related software components that run on computer system;

FIG. 6 is a flowchart of a monitoring process; and

FIG. 7 is a flowchart of a tunnel request handler process.

### DESCRIPTION OF THE SPECIFIC EMBODIMENTS

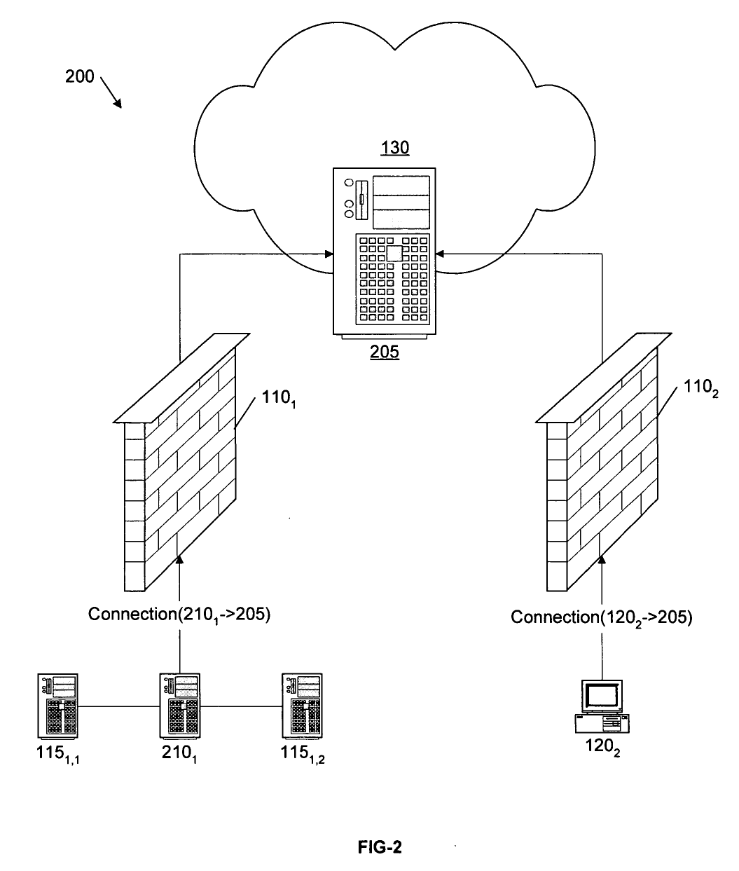

The present invention solves some of the access problems of TCP based client-server applications, and particularly it provides methods to publish TCP based client/server application, and tunnel a corresponding client via a global area computer network, through which, the TCP based server and client application are able to work across enterprise network boundaries in the same way as they work inside a enterprise network. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein. The preferred embodiments of the present invention and their advantages are best understood by referring to FIGS. 2 through 7 of the drawings.

FIG. 2 is a schematic block diagram of a preferred embodiment for a TCP tunneling architecture 200. Architecture 200 includes a service publishing/tunneling server 205 that provides a suitable server environment. Additionally, architecture 200 includes a dedicated computer system 210 (or, for example, it may be a client service on computer systems 115,) that provides an environment for a service proxy that implements service proxy functions as described below. Computer system 120ᵢ is the environment for a client part of the TCP based client/server applications, it also contains a set of tunneling components specified in this invention; Computer system 115_{1,1} and 115_{1,2} both provide an environment for a server part of the TCP based client/server applications.

In FIG. 2, service proxy 210₁ is deployed using a dedicated computer system, as another preferred embodiment. Service proxy 210ᵢ may run using the same computer systems as the TCP based client-server application(s) use. The computer system referred in this invention can be any type of electronic device that is capable of operation instructions to implement the functions that are specified in present invention. In the embodiment shown in FIG. 2, the computer system includes processor(s), memory, storage disks, operating system software, application software and communication software. Processor(s) can be any suitable processor, such as a member of the Intel Pentium family of processors. Memory can be any type of memory, such as DRAM, SRAM. Storage disks can be any type of devices that are designed for storing digital data such as hard disks, floppy disks. Operating system software can be any type of suitable operating system software that can run on the underlying hardware, such as Microsoft Windows (e.g., Windows NT, Windows 2000, Windows XP), a version of UNIX (e.g., Sun Solaris or Redhat LINUX). Application software can be of any software such as Microsoft SQL Server, Apache Web Server, a computer aided drafting application, or any other type of applications. Communication software includes any type of software that enables the data communication between computer systems and the software includes the instructions that implement functions specified in the present invention.

Global area computer network 100 (e.g., the Internet 100) includes any type of computer network that includes numerous computers that communicate with one another. In some embodiments of the present invention, global area computer network is shown as Internet.

Firewall 110ᵢ includes any hardware device or software system that enforces an access control between two networks, particularly, in some embodiments of the present invention, the two networks including an enterprise private network and global area computer network 100.

As described in greater detail below, the present invention provides systems and methods for tunneling TCP based client/server applications across enterprise network boundaries via global area computer network.

Before one or more services of TCP based client/server application(s) may be accessed from other enterprise networks, the service information is available on a known location by all the parties that are involved. Service publishing/tunneling server 205 provides this functionality. In addition, working with service proxy 210, server 205 also provides a mechanism to enable an indirect connection to be made between a client part and a server part of TCP based client/server applications.

As shown in FIG. 2, connections towards service publishing/tunneling server 205 may need to pass through one or more firewalls 110. A method to create such connections is described in my other US patent application, “SYSTEMS AND METHODS FOR BUILDING VIRTUAL NETWORKS” application Ser. No. 60/419,394, filed Oct. 18, 2003, and “APPARATUS, METHOD, AND COMPUTER PROGRAM PRODUCT FOR BUILDING VIRTUAL NETWORKS” application Ser. No. 10/653,638, filed 2 Sep. 2003, both hereby expressly incorporated by reference for all purposes.

In the preferred embodiment, there is discussion about TCP based client/server applications. To simplify the discussion, when the term client/server application is referenced, from the application point of view there is implicit the existence of the application containing at least two parts/processes, one is its client piece and other is its server piece. The server piece of the preferred embodiment provides service to the client piece, and the client piece uses the service to provide functionalities, the term “peer server” is about the server piece of the application. For example, in FIG. 2, server 115i and client 120i may work together as a client/server application, where 115i provides the service and 120i uses the service, 210i is the service proxy which will proxy the services provided by 115 is to their clients, 115i runs the “server peer” part of the application.

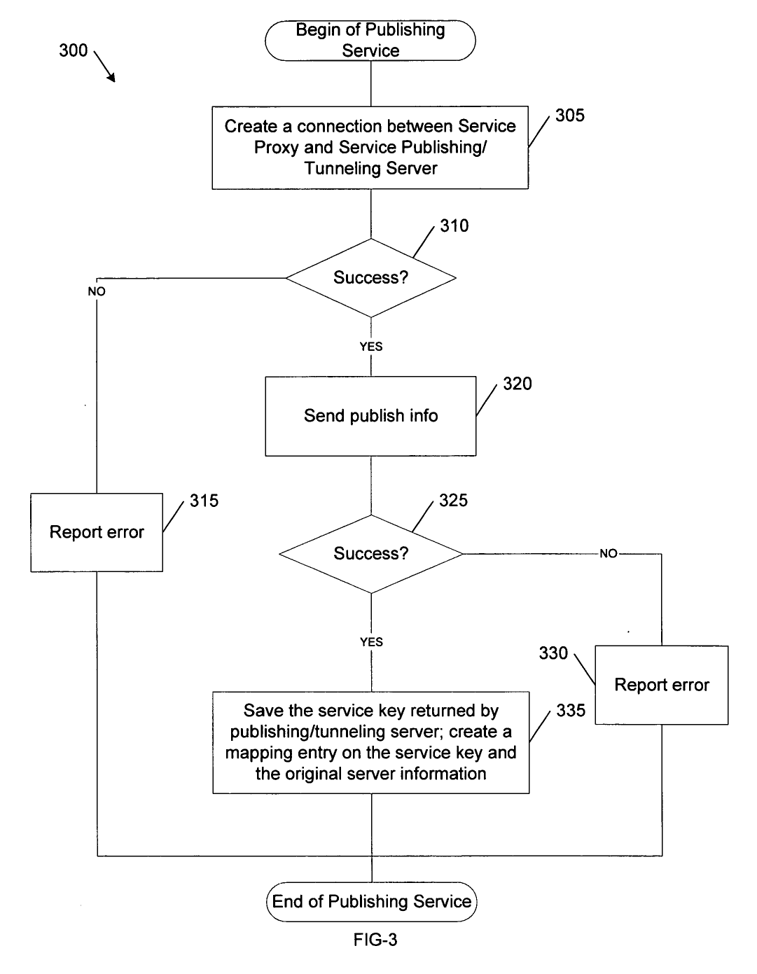

FIG. 3 is a flowchart diagram of a publishing process 300 that service proxy 210 uses to publish the service of a TCP based client/server application. At step 305, service proxy 210 requests creation of a connection to the service publishing/tunneling service 205. Preferably this connection uses the SSL Tunneling Protocol specified in the SYSTEMS AND METHODS FOR BUILDING VIRTUAL NETWORKS incorporated application, when necessary, though other connections/protocols may also be used. Step 310 determines whether the connection was successful. When the test at step 310 determines that the connection was not successfully created, process 300 branches to step 315 to report the error.

However, when the connection requested in step 305 is created successfully, process 300 advances to step 320 from step 310. Step 320 sends server publishing information over the connection.

Process 300 thereafter tests, step 325, whether the server publishing information was successfully sent. When the test at step 325 determines that the connection was not successfully created, process 300 branches to step 330 to report the error.

However, when the information is successfully published, process 300 advances to step 335 from step 325. When the service publishing/tunneling server 205 accepts the request, a service key is returned. Service proxy 210 saves the key and creates a mapping entry based on the key and the original server information in the publish request for future reference. The mapping entry is created based on the service key returned by the server and its original service information it wants to publish for future reference. The service information includes the address information of the service, and the address information should be able to be resolved by the service proxy in redirecting the TCP calls during the tunneling process.

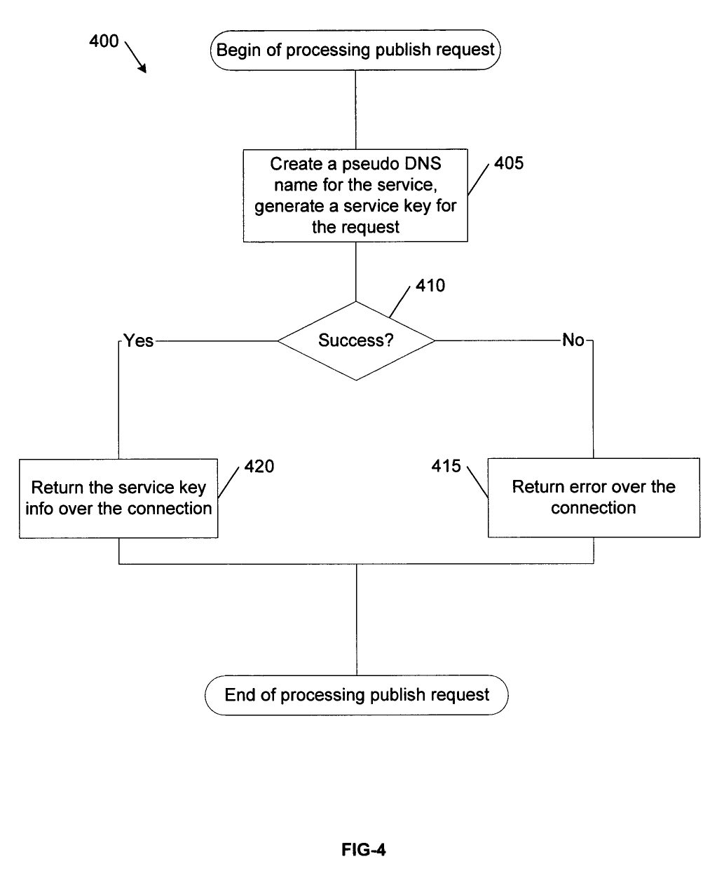

FIG. 4 is a flowchart of service key process 400 for server 205. On receipt of the publish request from service proxy 210, service publishing/tunneling server 205 performs service key process 400.

Process 400 begins with step 405, creating a pseudo DNS name for the service and generating a service key for the request. This pseudo DNS name is in the form of any regular DNS name, but will not be serviced by any DNS server. One of the purposes of using pseudo DNS name is to distinguish the services from each other and any other regular DNS names at a computer system executing a client part of the TCP based client/server application. In the preferred embodiment, the pseudo DNS name is resolved only at the client side by the socket hooking module without any need to contact a DNS server.

Process 400 tests whether step 405 was successful at test 410. When step 410 tests negative, process 400 returns an error indication over the connection at step 415. When step 410 tests affirmative, process 400 returns the service key information over the connection at step 420.

The service publishing/tunneling server 205 creates a service key for the received publish request, and it will also create a mapping entry based on the publish information and incoming connection of the publish request.

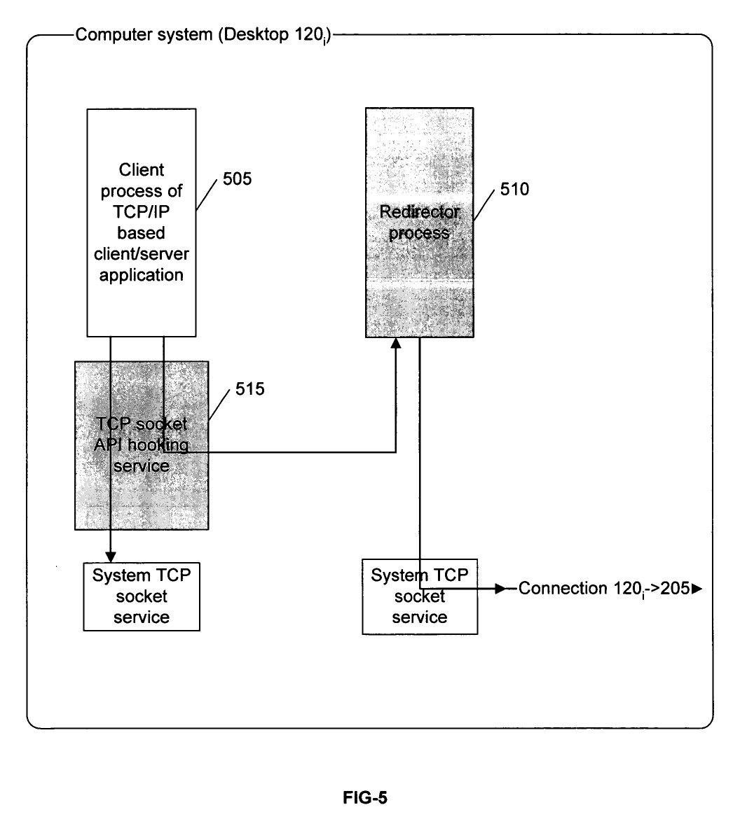

FIG. 5 is a functional block diagram illustrating related software components that run on computer system 120₂. These components includes a client process 505 of the TCP based client/server application, a redirector process 510, and a socket API hooking component 515. Software components 510 and 515 implement the processing logic specified in present invention.

Before a tunneling service according to the present invention is available on the computer system such as desktop 120₂, redirector process 510 creates a connection with the service publishing/tunneling server 205.

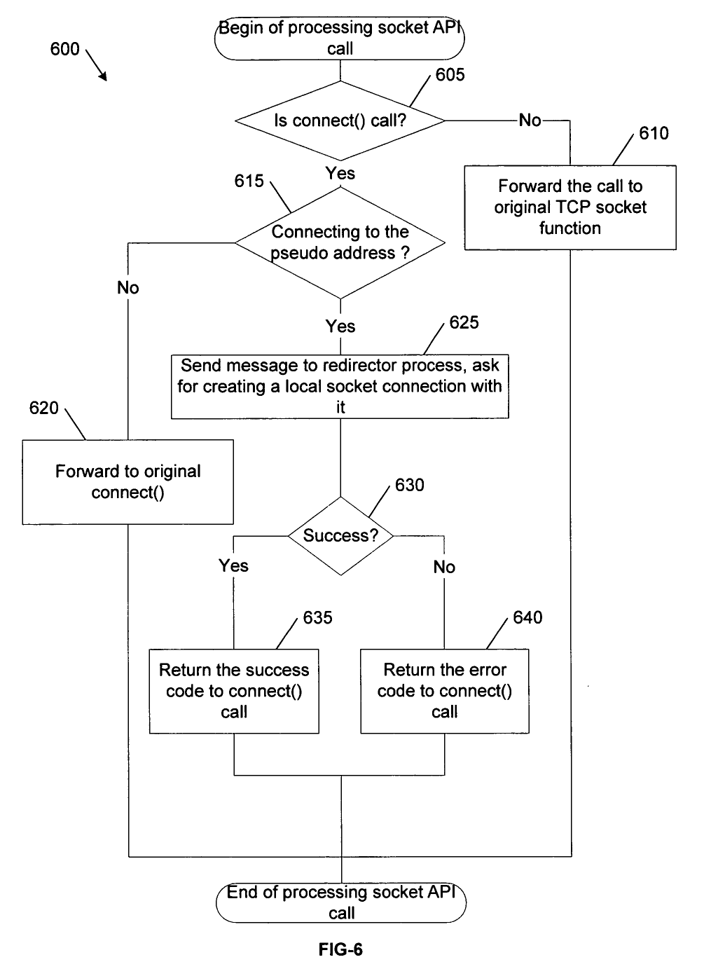

TCP socket API hooking component 515 is a software module that is injected into the client process of the client/server application, the major purpose for this injected module is to monitor the socket API calls issued from the client process. For all socket API calls, gethostbyname( ) and connect( ) function calls are handled specially as shown in FIG. 6, all other socket API calls will be passed through directly to the system TCP socket service, FIG. 5 also shows this processing flow.

FIG. 6 is a flowchart of a monitoring process 600. Process 600 (test step 605) tests whether a socket call is the connect( ) call. When the test at step 605 is negative, process 600 performs step 610 and forwards the call to the original TCP socket function. When hooking module 515 finds that a socket call is the socket connect( ) function call, it performs another test at step 615.

The test at step 615 determines whether the connect( ) call is connecting to the pseudo address resolved from the pseudo service DNS name. Any pseudo DNS name created in service publishing/tunneling server 205 during the service publishing process will be resolved to a pseudo address by hooking the gethostbyname( ) function call. When the target address does not match the pseudo address, process 600 performs step 620 and forwards the connect( ) call to the original connect( ).

However, when the target address in connect( ) function call matches the pseudo address of a published service, process 600 advances to step 625 from the test at step 615. Hooking module 515 sends an IPC(Inter-Process Call) call to redirector process 510 and requests creation of a local socket connection.

On receipt of the IPC call, redirector process 510 will in turn create a listen port locally to wait for the local connection to be created from the sender. Once the connect request is received afterwards, it will send a tunneling request over the connection that was created between it and service publishing/tunneling server 205. The tunneling request includes the information related to the pseudo DNS name learned by socket hooking module 515 in the client process of the TCP based client/server application.

Thereafter, process 600 tests (steps 630) whether the subprocess of step 625 was successful. When it was successful, process 600 returns a success code to the connect( ) call (step 635), and when it was unsuccessful, process 600 returns an error code to the connect( ) call (step 640).

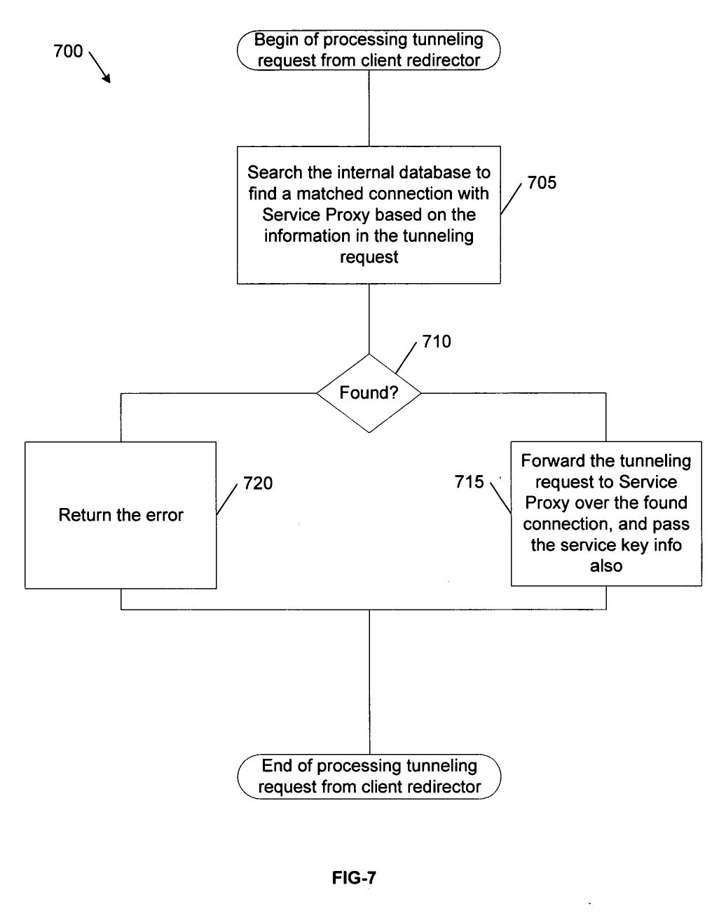

FIG. 7 is a flowchart of a tunnel request handler process 700. On receipt of the tunneling request from the client redirector process, service publishing/tunneling server 205 performs process 700 as shown in FIG. 7.

At step 705, process 700 using service publishing/tunneling server 205 searches its internal database to find a matched connection with service proxy 210 based on the information in the tunneling request. At step 710, process 700 tests whether the searched for connection was found.

When such a connection is found, process 700 forwards the tunneling request to the service proxy 210 over the connection along with the associated service key (step 715). When such a connection is not found, process 700 forwards an error indication (step 720).

On receipt of the tunneling request on service proxy 210, service proxy 210 searches the original server address of the TCP based client/server application based on the received tunneling request, when such a server does exist, it will create a socket connection with it and return the success info back.

The success information will be passed back along the connection chain described above, eventually the client redirector that originally issued the tunneling request will finish the local socket creation with the hooking module, which is injected into the client process of the TCP based client/server application. Therefore, a socket connect( ) from the client process will end with a connection chain between the client process and server process of the TCP based client/server application. This actually represents a virtual TCP connection that is able to work across the enterprise network boundaries. All data sent afterwards on this virtual TCP connection will be forwarded in the connection chain, thus making the client/server application work through enterprise network boundaries smoothly as if it were working within a single enterprise network.

One of the preferred implementations of the present invention is as a routine in an operating system made up of programming steps or instructions resident in the RAM of computer system, during computer operations. Until required by computer system, the program instructions may be stored in another readable medium, e.g. in the disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

The invention has been described with reference to particular embodiments thereof. However, these embodiments are merely illustrative, not restrictive, of the invention, the scope of which is to be determined solely by the appended claims.

What is claimed is:

1. A tunneling system, comprising:
a service publishing/tunneling server coupled to a wide-area network; and
a service proxy, coupled to one or more computer systems, for implementing one or more service proxy functions;
wherein a TCP service for said one or more client computer systems is available from said server through said service proxy.

2. The tunneling system of claim 1 wherein said one or more computer systems are separated from said server by one or more firewalls.

3. The tunneling system of claim 1 wherein said one or more computer systems are included in different enterprise networks.

4. The tunneling system of claim 3 further comprising one or more clients and one or more server applications distributed over said one or more computer systems.

5. The tunneling system of claim 4 wherein a client part includes an indirect connection to a server application.

6. The tunneling system of claim 1 wherein said TCP service is published to said server by said service proxy.

7. The tunneling system of claim 6 wherein said service proxy sends publish information to said server after creating a connection to said server.

8. The tunneling system of claim 7 wherein said service proxy saves a service key returned by said server.

9. The tunneling system of claim 8 wherein said service proxy creates a mapping entry responsive to said service key.

10. The tunneling system of claim 6 wherein said server creates a pseudo DNS name for said service.

11. The tunneling system of claim 6 wherein said server creates a service key responsive to said publish information.

12. The tunneling system of claim 9 wherein said server creates a pseudo DNS name for said service.

13. The tunneling system of claim 9 wherein said server creates a service key responsive to said publish information.

14. The tunneling system of claim 12 wherein said server creates a service key responsive to said publish information.

15. The tunneling system of claim 1 wherein one of said computer systems includes a client application, and wherein said client application includes a TCP socket hooking service to selectively respond to TCP service calls.

16. The tunneling system of claim 15 wherein said hooking service is responsive to a connect( ) call to selectively redirect said call based upon a content of said connect( ) call.

17. The tunneling system of claim 10 wherein one of said computer systems includes a client application, and wherein said client application includes a TCP socket hooking service to selectively respond to TCP service calls.

18. The tunneling system of claim 17 wherein said hooking service is responsive to a connect( ) call to selectively redirect said call based upon a content of said connect( ) call.

19. The tunneling system of claim 18 wherein said content of said connect( ) call includes said pseudo DNS name.

20. The tunneling system of claim 19 wherein said one client application includes a redirector process.

21. The tunneling system of claim 10 wherein said pseudo DNS is resolved at a client side.

22. A method for tunneling a TCP service, the method comprising:
a) connecting a service proxy to a service publishing/tunneling server, wherein said server is coupled to a wide-area network and said service proxy is coupled to one or more computer systems for implementing one or more service proxy functions;
b) sending, from said proxy, publishing information for a particular service to said server;
c) receiving a service key for said particular service from said server; and
d) using said service key to provide said particular service to said one or more client computer systems from said server through said service proxy.

23. The method of claim 22 further comprising:
e) creating a mapping entry on said service proxy responsive to said service key and to said publishing information.

24. The method of claim 23 wherein said mapping entry includes a pseudo DNS name.

25. The method of claim 24 wherein said pseudo DNS name was generated by said server responsive to said publishing information.

26. The method of claim 24 wherein said DNS name is resolved on a client side.

27. The method of claim 26 wherein said DNS name is resolved without accessing an external DNS service outside the service proxy.

28. The method of claim 22 further comprising:
e) redirecting a TCP connect call from a client application to a server peer via a connection chain using a redirector process.

29. The method of claim 28 wherein said step of redirecting e) is responsive to said pseudo DNS name and said service key.

30. The method of claim 28 wherein said connection chain is a virtual TCP connection that functions as a real TCP connection.

31. The method of claim 30 wherein said chain connection couples, in sequence, said client application to said redirector process to said publishing/tunneling server to said service proxy to said server peer.

32. The method of claim 31 wherein said virtual TCP connection is a two-way connection between said client application and said server peer wherein data transfer may occur in both directions.

33. A method for tunneling a TCP service, the method comprising:
a) connecting a service proxy to a service publishing/tunneling server, wherein said server is coupled to a wide-area network and said service proxy is coupled to one or more computer systems for implementing one or more service proxy functions;
b) receiving, from said proxy, publishing information for a particular service at said server; and
c) transmitting a service key for said particular service from said server;
wherein said service key is used to provide said particular service to said one or more client computer systems from said server through said service proxy.

34. An apparatus for tunneling, comprising:
means for connecting a service proxy to a service publishing/tunneling server, wherein said server is coupled to a wide-area network and said service proxy is coupled to one or more computer systems for implementing one or more service proxy functions;
means for sending, from said proxy, publishing information for a particular service to said server;
means for receiving a service key for said particular service from said server; and
means for using said service key to provide said particular service to said one or more client computer systems from said server through said service proxy.

35. An apparatus for tunneling, comprising:
means for connecting a service proxy to a service publishing/tunneling server, wherein said server is coupled to a wide-area network and said service proxy is coupled to one or more computer systems for implementing one or more service proxy functions;
means for receiving, from said proxy, publishing information for a particular service at said server; and
means for transmitting a service key for said particular service from said server; wherein said service key is used to provide said particular service to said one or more client computer systems from said server through said service proxy.

36. A computer program product comprising a computer readable medium carrying program instructions for tunneling TCP services when executed using two or more computing systems each coupled to a global area network, the executed program instructions executing a method, the method comprising:
a) connecting a service proxy to a service publishing/tunneling server, wherein said server is coupled to a wide-area network and said service proxy is coupled to one or more computer systems for implementing one or more service proxy functions;
b) sending, from said proxy, publishing information for a particular service to said server;
c) receiving a service key for said particular service from said server; and
d) using said service key to provide said particular service to said one or more client computer systems from said server through said service proxy.

37. The computer program product of claim 36 further comprising:
e) creating a mapping entry on said service proxy responsive to said service key and to said publishing information.

38. The computer program product of claim 37 wherein said mapping entry includes a pseudo DNS name.

39. The computer program product of claim 38 wherein said pseudo DNS name was generated by said server responsive to said publishing information.

40. The computer program product of claim 38 wherein said DNS name is resolved on a client side.

41. The computer program product of claim 40 wherein said DNS name is resolved without accessing an external DNS service.

42. A computer program product comprising a computer readable medium carrying program instructions for tunneling TCP services when executed using two or more computing systems each coupled to a global area network, the executed program instructions executing a method, the method comprising:
a) connecting a service proxy to a service publishing/tunneling server, wherein said server is coupled to a wide-area network and said service proxy is coupled to one or more computer systems for implementing one or more service proxy functions;
b) receiving, from said proxy, publishing information for a particular service at said server; and
c) transmitting a service key for said particular service from said server; wherein said service key is used to provide said particular service to said one or more client computer systems from said server through said service proxy.
